(19) United States
(12) Patent Application Publication
(10) Pub. No.: US 2005/0014039 A1
(43) Pub. Date: Jan. 20, 2005

(54) Fuel cell arrangement and method for operating a fuel cell arrangement

(76) Inventor: Stefan Rolf, Munchen (DE)

Correspondence Address: CROWELL & MORING LLP;INTELLECTUAL PROPERTY GROUP, P.O. BOX 14300, WASHINGTON, DC, 20044-4300, US

(21) Appl. No.: 10/467,525

(22) PCT Filed: Feb. 8, 2002
(86) PCT No.: PCT/EP02/01315

(30) Foreign Application Priority Data
Feb. 10, 2001 (DE) 101 06 219.2

(51) Int. Cl. H01M 8/04

(52) U.S. Cl. 429/13; 429/26; 429/23

(57) ABSTRACT

A fuel cell arrangement (10) and its operation are described. This fuel cell arrangement (10) comprises one or more fuel cells (1) to which a combustible gas or a cathode gas is fed and which supply an electric power Pext to an external consuming device (2). One or more internal electrical consuming devices (3) can optionally be switched on and off by means of a control device (5) as a function of the operating condition of the fuel cell arrangement (10). Excessive heat is removed from the fuel cell arrangement by means of a cooling device (4). According to the invention, a portion of the electric power PBZ generated by the fuel cells (1) is converted at the internal electrical consuming devices (3) during the operation of the fuel cell arrangement (10). When the electric power Pext supplied to the external electrical consuming device (2) increases or decreases, the electric power Pint converted at the internal electrical consuming devices (3) is reduced or increased inversely in the sense of making the electric power PBZ generated by the fuel cells (1) uniform. This is carried out by the control device (5) of the fuel cell arrangement (10).

### CROSS-REFERENCE TO RELATED APPLICATIONS

This application claims priority to German Patent Application No. 101 06 219.2, which was filed Feb. 10, 2001.

### FIELD OF THE INVENTION

The invention relates to a method of operating a fuel cell arrangement and further to a fuel cell arrangement.

### BACKGROUND OF THE INVENTION

Fuel cell arrangements are known which comprise one or more fuel cells to which a combustible gas and a cathode gas are fed and which supply electric power to an external consuming device. One or more internal electrical consuming devices of the fuel cell arrangement can optionally be switched on and off. A cooling device is provided for eliminating excessive heat from the fuel cell arrangement.

One difficulty during the operation of fuel cell arrangements of the above-mentioned type is the fact that, with respect to their performance, they cannot arbitrarily rapidly follow a change of the electric load of the connected external consuming device. The reason is based less on the dynamics of the electrochemical events taking place in the fuel cells than in the slowness of supplying the fuel cells with their reaction gases: the combustible gas and the cathode gas. The load-following operation therefore requires electric power at the expense of the efficiency in order to be able to immediately react in the event of a load demand. In the case of a power supply system failure, i.e., in the event of a sudden failure of the load demand of the connected external consuming device, the fuel cell arrangement, if possible, should not switch off but change to a standby operation, in which the current requirement for the internal consuming devices of the fuel cell arrangement is covered. The intrinsic consumption of the fuel cell arrangement is minimized for economical reasons, so that the system generates little electric power. In the load-following operation, the amount of the current production of a fuel cell arrangement is defined by the external consuming devices connected to it. Such a condition, which is also called an “island operation”, particularly in the case of small system sizes, results in load demands, which fluctuate considerably with respect to their percentages as a result of the connecting or disconnecting of individual consumption points. Rapid load changes occur during failures of the external consuming device, for example, in the event of a power supply system failure. The fuel cell arrangement will then supply no electric power to the external consuming device. In this case, the fuel cell arrangement is to change to a standby operation in which it generates just enough electric power in order to satisfy the intrinsic consumption.

### SUMMARY OF THE INVENTION

It is an object of the invention to provide a method of operating a fuel cell arrangement of the initially mentioned type by means of which the fuel cell arrangement can be operated in the sense of a fast response to changing load requirements. Furthermore, by means of the invention, a fuel cell arrangement may be created which is capable of rapidly responding to changing load requirements.

With respect to the method, the object is achieved by means of the method of operating a fuel cell arrangement indicated herein.

With respect to the device, the object is achieved by means of the fuel cell arrangement indicated herein.

The invention creates a method of operating a fuel cell arrangement having one or more fuel cells, to which a combustible gas and a cathode gas are fed and which supply electric power to an external consuming device, and having one or more internal electrical consuming devices which can optionally be switched on and off, as well as having a cooling device by which excessive heat is eliminated from the fuel cell arrangement. According to the invention, it is provided that, in the operation of the fuel cell arrangement, a portion of the electric power generated by the fuel cells is converted at the internal electrical consuming devices, and that, in the case of an increase or decrease of the electric power supplied to the external electrical consuming device, the electric power converted at the internal electrical consuming devices is reduced or increased inversely in the sense of making the electric power generated by the fuel cells uniform.

It is an advantage of the method according to the invention that, while the generating of the electric power is uniform, the fuel cells can rapidly respond to a change of the load demand by the external electrical consuming device.

According to a preferred embodiment of the invention, it is provided that, for a load-following operation, an increase of the power supplied to the external electrical consuming device is compensated by a reduction of the electric power converted at the internal electrical consuming devices, and a reduction of the power supplied to the external electrical consuming device is compensated by an increase of the power converted at the internal electrical consuming devices.

According to another aspect of the invention, it is provided that, for a standby operation, a switching-off of the external electrical consuming device is compensated by an increase of the electric power converted at the internal electrical consuming devices.

It is preferably provided that the change of the electric power inverted at the internal electrical consuming devices takes place essentially immediately with the change of the power supplied to the external electrical consuming device.

Here, it is particularly advantageous for the electric power generated by the fuel cells to be kept essentially constant.

According to an advantageous embodiment of the invention, it is provided that maximally an electric power is converted at the internal electrical consuming devices which amounts to approximately one fourth to approximately half of the nominal electric power of the fuel cells.

Preferably, the electric power converted at the internal electrical consuming devices is removed from the fuel cell arrangement by an increased use of the cooling device.

Furthermore, by means of the invention, a fuel cell arrangement is created which has one or more fuel cells to which a combustible gas and a cathode gas are fed and which supply an electric power to an external consuming device, and which has one or more internal electrical consuming devices which can optionally be switched on and off, and which has a cooling device by means of which the excessive heat is removed from the fuel cell arrangement, and which has a control device for controlling the operation of the internal consuming devices as a function of the operating condition of the fuel cell arrangement. According to the invention, it is provided that the control device controls the internal electrical consuming devices such that a portion of the electric power generated by the fuel cells is converted at the internal electrical consuming devices, and that, in the case of an increase or decrease of the electric power supplied to the external electrical consuming device, the electric power converted at the internal electrical consuming devices is reduced or increased inversely in the sense of making the electric power generated by the fuel cells uniform.

It is an advantage of the fuel cell arrangement according to the invention that, while the generating of the electric power is essentially uniform, this fuel cell arrangement can rapidly respond to a change of the load demand of the connected electrical consuming device.

According to an aspect of the invention, it is provided that the control device controls the internal electrical consuming devices such that, for a load-following operation, an increase of the power supplied to the external electrical consuming device is compensated by a reduction of the electric power converted at the internal electrical consuming devices, and a reduction of the power supplied to the external electrical consuming device is compensated by an increase of the electric power converted at the internal electrical consuming devices.

According to another aspect of the invention, it is provided that the control device controls the internal electrical consuming devices such that, for a standby operation, a switching-off of the external electrical consuming device is compensated by an increase of the electric power converted at the internal electrical consuming devices.

Preferably, it is provided that the control device controls the internal electrical consuming devices such that the change of the electric power converted at the internal electrical consuming devices takes place essentially immediately with the change of the power supplied to the external electrical consuming device.

Furthermore, it is an advantage for the control device to control the internal electrical consuming devices such that the electric power generated by the fuel cells is essentially kept constant.

According to an advantageous embodiment of the invention, it is provided that maximally an electric power is converted at the internal electrical consuming devices which amounts to approximately one fourth to approximately half of the nominal electric power of the fuel cells.

Furthermore, it is advantageous for the cooling device to be constructed such that it removes the electric power converted at the internal electrical consuming devices from the fuel cell arrangement.

Advantageously, the internal electrical consuming devices comprise a start heating device and/or a ventilating device and/or other aggregates of the fuel cell arrangement.

According to a preferred embodiment of the invention, it is provided that the fuel cell arrangement comprises an electrical inverter for converting the direct voltage supplied by the fuel cells into an alternating voltage which is fed to the external consuming device.

Finally, according to an advantageous embodiment of the invention, it is provided that the internal electrical consuming devices can be connected by means of the control device optionally parallel to the external electric consuming device with the output of the inverter.

### BRIEF DESCRIPTION OF THE DRAWINGS

FIG. 1 illustrates a block diagram of a fuel cell arrangement according to an embodiment of the invention.

### DETAILED DESCRIPTION OF THE INVENTION

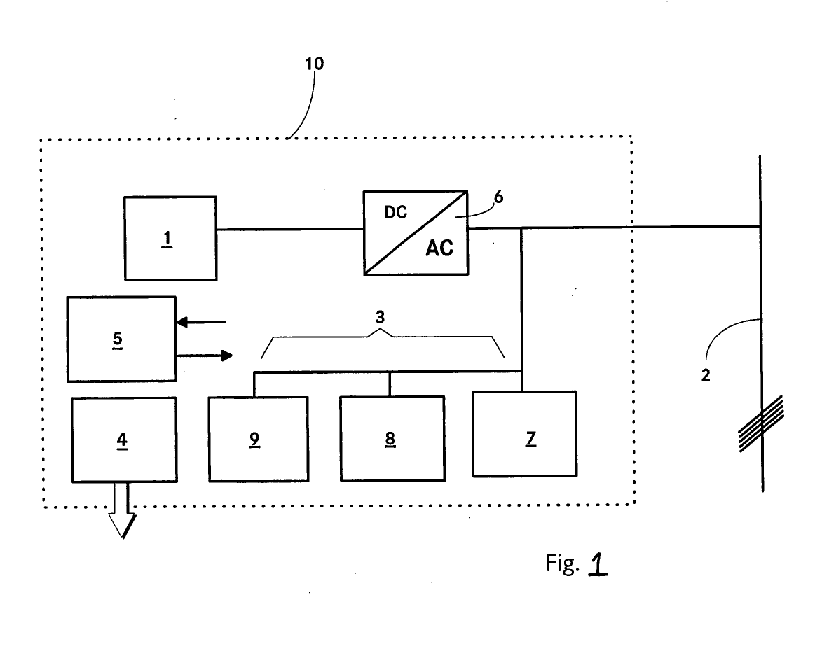

FIG. 1 illustrates a fuel cell arrangement which, as a whole, has the reference number 10, and comprises one or more fuel cells 1. A combustible gas and a cathode gas are fed (not shown in the figure) to the fuel cells 1, from which electric energy is obtained in an electrochemical manner. This electric energy is supplied by the fuel cells 1 to an external consuming device 2 as electric power Pext. The external consuming device 2 is illustrated in FIG. 1 as an electrical line network, which supplies several consuming points that are not separately shown in the figure.

The fuel cell arrangement 10 comprises one or more internal electrical consuming devices 3 which are used for the operation of the fuel cell arrangement 10 and which can optionally be switched on and off. Such internal electrical consuming devices 3 may, for example, comprise a start heating device 7 required for the starting operation and/or a ventilator device 8 required for the circulation of reaction gases, such as the combustible gas and the cathode gas or a cooling gas, and/or other aggregates 9 of the fuel cell arrangement. The fuel cell arrangement 10 also has a cooling device 4 by means of which excessive heat generated during the operation of the fuel cell arrangement 10 is removed from the latter. A control device 5 is used for controlling the operation of the internal consuming devices 3 as a function of the operating condition of the fuel cell arrangement 10.

During the operation of the fuel cell arrangement 10, a portion of the electric power PBZ generated by the fuel cells 1 is converted at the internal electrical consuming devices 3. When the electric power Pext supplied to the external electrical consuming device 2 increases or decreases, the electric power Pint converted at the internal electrical consuming devices 3 is inversely reduced or increased in the sense of making the electric power PBZ generated by the fuel cells uniform. The control device 5 controls the internal electrical consuming devices 3 in this sense.

For a load-following operation, thus an operation in which the fuel cell arrangement adapts the electric power provided by it to the load requirement of the connected external consuming device 2, that is, of the connected electrical power supply system, an increase of the power Pext supplied to the external electrical consuming device 2 is compensated by a reduction of the electric power Pint converted at the internal electrical consuming devices 3. In a corresponding manner, a reduction of the power Pext supplied to the external electrical consuming device 2 is compensated by an increase of the electric power Pint converted at the internal electrical consuming devices 3.

For a standby operation, thus an operation in which, for example, in the event of the failure of the connected power supply system, or if its load requirement should be zero, no electric power Pext can be supplied anymore to the outside, a switching-off of the external electrical consuming device 2, for example, the above-mentioned power supply system failure, is compensated by an increase of the electric power Pint converted at the internal electrical consuming device 3. As a result, the fuel cell arrangement does not have to be moved to a minimal operating point but can still generate electric power in the amount of the electric power Pint converted at the internal electrical consuming devices 3. As required, thus when the external electrical consuming device 2, that is the connected power supply system, is restored, this power will immediately be available again.

The change of the electric power Pint converted at the internal electrical consuming devices 3 essentially takes place immediately with the change of the power Pint supplied to the external electrical consuming device 2. This is carried out by the control device 5. The electric power PBZ generated by the fuel cells 1 is kept essentially constant; that is, PBZ−Pint=Pext.

In the embodiment described here, the internal electrical consuming devices 3 are dimensioned such that maximally an electric power Pint is converted which amounts approximately to one quarter to approximately half of the nominal electric power of the fuel cells 1. The electric power Pint converted at the internal electrical consuming devices 3 is removed from the fuel cell arrangement 10 by an increased use of the cooling device 4.

The electric power supplied by the fuel cells 1 to the external consuming device 2 is converted by an inverter 6 provided in the fuel cell arrangement 10 from the direct voltage supplied by the fuel cells 1 to an alternating voltage that is supplied to the external consuming device 2. The internal electrical consuming devices 3 can be connected by means of the control device 5 optionally parallel to the external electrical consuming device 2 with the output of the inverter 6.

The adaptation of the electric power Pint converted at the internal electrical consuming devices 3 to the power Pext supplied to the external electrical consuming device 2 in the sense of making the electric power PBZ uniform which is generated by the fuel cells 1, can take place in steps or continuously, depending on the type and construction of the control device 5 by means of which this adaptation is carried out.

1-40. (Cancelled)

41. A method of operating a fuel cell arrangement having at least one fuel cell comprising: feeding a combustible gas and a cathode gas to said fuel cell arrangement; supplying an electric power Pext to an external consuming device; optionally switching on and off at least one internal electrical consuming device; and removing excessive heat from said fuel cell arrangement by a cooling device; wherein an electric power PBZ is generated by said at least one fuel cell, and an electric power Pint is consumed by said at least one internal electrical consuming device, said power Pint being a portion of said power PBZ.

42. The method of claim 41, wherein an increase or decrease of said power Pext causes a decrease or increase in said power Pint, respectively.

43. The method of claim 41, wherein said power Pext and said power Pint are inversely related.

44. The method of claim 42, wherein said power PBZ is uniform.

45. The method of claim 43, wherein, for a load-following operation, an increase of said power Pext supplied to said external electrical consuming device is compensated by a reduction of said power Pint, and a reduction of said power Pext is compensated by an increase of said power Pint.

46. The method of claim 45, wherein, for a standby operation, a switching-off of said external electrical consuming device is compensated by an increase in said power Pint.

47. The method of claim 46, wherein a change of said power Pint takes place essentially immediately with a change of the power Pext.

48. The method of claim 47, wherein said power PBZ is kept essentially constant.

49. The method of claim 48, wherein said power Pint maximally amounts to approximately one fourth to approximately one half of a nominal electric power of said at least one fuel cell.

50. The method of claim 48, wherein said power Pint is removed from said fuel cell arrangement by an increased use of said cooling device.

51. A fuel cell arrangement having at least one fuel cell comprising:
at least one internal electrical consuming device, said at least one internal electrical consuming device being optionally switched on and off;
a cooling device for removing excess heat from said fuel cell arrangement; and
a control device, said control device controlling said at least one internal electrical consuming device as a function of an operating condition of said fuel cell arrangement;
wherein an electric power PBZ is generated by said fuel cell arrangement,
an electric power Pint is consumed by said at least one internal electrical consuming device, said power Pint being a portion of said power PBZ, and
an electric power Pext is consumed by an external consuming device.

52. The fuel cell arrangement of claim 51, wherein an increase or decrease of said power Pext causes a decrease or increase in said power Pint, respectively.

53. The fuel cell arrangement of claim 51, wherein said power Pext and said power Pint are inversely related.

54. The fuel cell arrangement of claim 52, wherein said power PBZ is uniform.

55. The fuel cell arrangement of claim 53, wherein, for a load-following operation, said control device controlling said at least one internal consuming device such that an increase of said power Pext is compensated by a reduction of said power Pint, and a reduction of said power Pext is compensated by an increase of said power Pint.

56. The fuel cell arrangement of claim 55, wherein, for a standby operation, said control device controlling said at least one internal consuming device such that a switching-off of said external electrical consuming device is compensated by an increase in said power Pint.

57. The fuel cell arrangement of claim 56, wherein said control device controlling said at least one internal consuming device such that a change of said power Pint takes place essentially immediately with a change of the power Pext.

58. The fuel cell arrangement of claim 57, wherein said control device controlling said at least one internal consuming device such that said power PBZ is kept essentially constant.

59. The fuel cell arrangement of claim 58, wherein said control device controlling said at least one internal consuming device such that said power Pint maximally amounts to approximately one fourth to approximately one half of a nominal electric power of said fuel cell arrangement.

60. The fuel cell arrangement of claim 58, wherein said cooling device is constructed such that it removes said power Pint from said fuel cell arrangement.

61. The fuel cell arrangement of claim 60, said at least one internal electrical consuming device further comprising at least one of a start heating device, a ventilator device, and another aggregate.

62. The fuel cell arrangement of claim 61, further comprising an electrical inverter for converting a direct voltage supplied by said at least one fuel cell into an alternating voltage, said alternating voltage being supplied to said external consuming device.

63. The fuel cell arrangement of claim 62, wherein said at least one internal electrical consuming device being connected, via said control device, to said external electrical consuming device in parallel with an output of said inverter.
